(19) United States
(12) Patent Application Publication
(10) Pub. No.: US 2026/0064961 A1
(43) Pub. Date: Mar. 5, 2026

(54) ISSUE MONITORING APPARATUS AND METHOD USING LANGUAGE MODEL BASED ON GENERATIVE ARTIFICIAL INTELLIGENCE

(71) Applicant: 2DIGIT Inc., Seongnam-si (KR)

(72) Inventors: Seok Jun PARK, Yongin-si (KR); Chang Yeon KIM, Yongin-si (KR); Young Jun HWANG, Seoul (KR)

(21) Appl. No.: 18/826,279

(22) Filed: Sep. 6, 2024

(30) Foreign Application Priority Data
Aug. 28, 2024 (KR) 10-2024-0115478

(51) Int. Cl. G06F 40/20; G06F 16/383

(52) U.S. Cl. CPC G06F 40/20; G06F 16/383

(57) ABSTRACT

Disclosed are an apparatus and a method for performing issue monitoring using a language model based on a generative artificial intelligence. An issue monitoring apparatus according to an exemplary embodiment includes an interface unit which inputs and outputs data with an external device and an analysis unit which analyzes an issue about a specific topic from input data received through the interface unit using a generative artificial intelligence based language model to generate first metadata.

### CROSS-REFERENCE TO RELATED APPLICATIONS

This application claims the priority of Korean Patent Application No. 10-2024-0115478 filed on Aug. 28, 2024, in the Korean Intellectual Property Office, the disclosure of which is incorporated herein by reference.

### BACKGROUND

### Field

The present disclosure relates to an apparatus and a method for performing issue monitoring using a language model based on a generative artificial intelligence.

### Description of the Related Art

Recently, various services using large language model (LLM) are being studied. The large language model is an artificial intelligence model which understands and generates human language by learning a vast amount of text data. These models are based on natural language processing (NLP) technologies and may perform various language-related tasks, such as text generation, translation, summarization, and question answering. Notable examples include OpenAI's GPT-3, GPT-4, Google's Gemini, and Meta's Llama2 and these models have abilities of imitating human language patterns and processing complex language tasks using hundreds of millions to hundreds of billions of parameters.

Korean Registered Patent No. 10-2658456 discloses a feature of a system for automatic generation of large scale of language survey model based research analysis report.

### SUMMARY

An object is to provide an apparatus and a method for performing issue monitoring using a language model based on a generative artificial intelligence.

According to an aspect, an issue monitoring apparatus may include an interface unit which inputs and outputs data with an external device; and an analysis unit which analyzes an issue about a specific topic from input data received through the interface unit using a generative artificial intelligence based language model to generate first metadata.

The specific topic is at least one of issues, such as a person, a product, a country, and an event which is set in advance by a user or determined based on data acquired through the interface unit according to a predetermined rule.

The analysis unit analyzes an issue about a specific topic from input data received after generating the first metadata to generate second metadata.

The analysis unit analyzes a similarity of the first metadata and the second metadata to determine whether it is a new issue or a related issue, based on the similarity.

When a new issue occurs, the analysis unit may transmit notification information to a user through the interface unit.

The analysis unit may generate one or more questions for follow-up data search based on at least one of a specific issue and the first metadata.

The analysis unit receives answers corresponding to one or more questions and performs search and filtering according to the answers to receive input data.

The analysis unit repeatedly generates one or more metadata based on input data which is received for a predetermined time and determines a similarity between one or more repeatedly generated metadata to determine metadata having a similarity which is equal to or higher than a predetermined criterion as one or more effective metadata and delete one or more metadata having a similarity which is lower than a predetermined criterion.

The analysis unit determines any one of one or more effective metadata as representative effective metadata according to a predetermined criterion and may determine whether it is a new issue or a related issue based on the representative effective metadata.

When one issue includes two or more topics, the analysis unit performs the clustering for every topic and may generate metadata for every clustering.

According to an aspect, an issue monitoring method which is carried out on a computing device including one or more processors and a memory which stores one or more programs executed by the one or more processors, includes receiving input data from an external device; and an analysis step of analyzing an issue about a specific topic from received input data using a generative artificial intelligence based language model to generate first metadata.

In the analysis step, an issue about a specific topic is analyzed from input data received after generating the first metadata to generate second metadata.

In the analysis step, a similarity of the first metadata and the second metadata is analyzed to determine whether it is a new issue or a related issue, based on the similarity.

In the analysis step, when a new issue occurs, notification information may be transmitted to a user.

In the analysis step, one or more questions for follow-up data search may be generated based on at least one of a specific issue and the first metadata.

In the analysis step, answers corresponding to one or more questions are received and search and filtering are performed according to the answers to receive input data.

In the analysis step, one or more metadata is repeatedly generated based on input data which is received for a predetermined time and a similarity between one or more repeatedly generated metadata is determined to determine metadata having a similarity which is equal to or higher than a predetermined criterion as one or more effective metadata and delete one or more metadata having a similarity which is lower than a predetermined criterion.

In the analysis step, any one of one or more effective metadata is determined as representative effective metadata according to a predetermined criterion and it may be determined whether it is a new issue or a related issue based on the representative effective metadata.

In the analysis step, when one issue includes two or more topics, the clustering is performed for every topic and metadata is generated for every clustering.

According to the exemplary embodiment, a user may check the changes in issues related to a specific topic in a timely manner without manually searching for information on that topic.

Further, a new issue which has not been previously learned can be identified and is refined to be provided to the user, thereby significantly improving the efficiency of information search and analysis.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram of an issue monitoring apparatus according to an exemplary embodiment;

FIG. 2 is an exemplary diagram for explaining an operation environment of an issue monitoring apparatus according to an exemplary embodiment;

FIGS. 3, 4, 5, 6 and 7 are exemplary diagrams for explaining an operating method of an issue monitoring apparatus; and

FIG. 8 is a flowchart illustrating an issue monitoring method according to an exemplary embodiment.

### DETAILED DESCRIPTION OF EXEMPLARY EMBODIMENTS

Hereinafter, an exemplary embodiment of the present disclosure will be described in detail with reference to the accompanying drawings. In the description of the present disclosure, a detailed description of known configurations or functions incorporated herein will be omitted when it is determined that the detailed description may make the subject matter of the present disclosure unclear. Further, the terms to be described below are defined considering the functions in the present disclosure and may vary depending on the intention or usual practice of a user or operator. Accordingly, the terms need to be defined based on details throughout this specification.

Hereinafter, exemplary embodiments of an issue monitoring apparatus and method will be described in detail with reference to drawings.

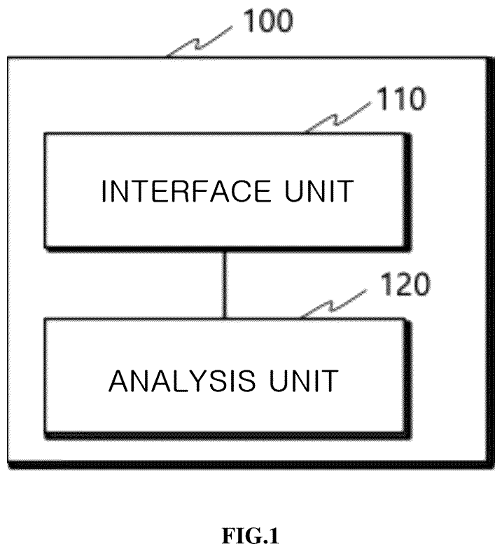

FIG. 1 is a diagram of an issue monitoring apparatus according to an exemplary embodiment.

According to the exemplary embodiment, the issue monitoring apparatus 100 may include an interface unit 110 for data input/output with an external device and an analysis unit 120 which analyzes an issue about a specific topic from input data received through the interface unit using a generative artificial intelligence based language model to generate first metadata.

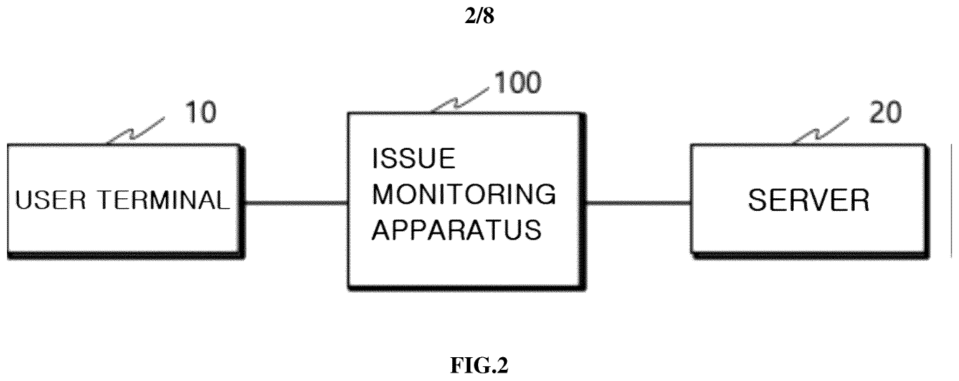

According to an example, the interface unit 110 transmits and receives data by communicating with at least one of one or more user terminals 10 and one or more servers 20 as illustrated in FIG. 2. For example, the issue monitoring apparatus 100 receives user setting information from the user terminal 10 and outputs and transmits the generated information. Further, the issue monitoring apparatus 100 receives raw data to be analyzed or searches for necessary information from the server 20.

According to an example, the analysis unit 120 may include a generative artificial intelligence based language model. The analysis unit 120 constructs a generative artificial intelligence based language model and analyzes issue information about a specific topic acquired from the Internet using the same. For example, the analysis unit 120 automatically monitors issue changes in real time and provides information about the occurrence of issue changes to the user in a timely manner and may provide customized reporting on issue changes in specific topics that are highly sensitive to the user.

By doing this, the user may identify that the issue related to the corresponding topic has changed in a timely manner without manually searching for information about an interested specific topic. For example, the issue monitoring apparatus 100 may identify new issues of a specific member A from gossip news about a K-POP idol group and report the new issues to international fans of the member A. As another example, the issue monitoring apparatus 100 may identify new issues about a stock item X in country A and report new issues to foreign investors regarding the stock X. At this time, the issue monitoring apparatus 100 may report the issue information which is translated into a language set by the user who receives the issue information.

For example, the generative artificial intelligence based language model may be trained in advance by a predetermined method and a type and a training method of the language model may vary according to an implementation condition. The generative artificial intelligence based language model extracts core contents considering the context from issue information obtained using the generative artificial intelligence technology and the natural language analysis technology and generates metadata containing one or more keywords and one or more summary sentences.

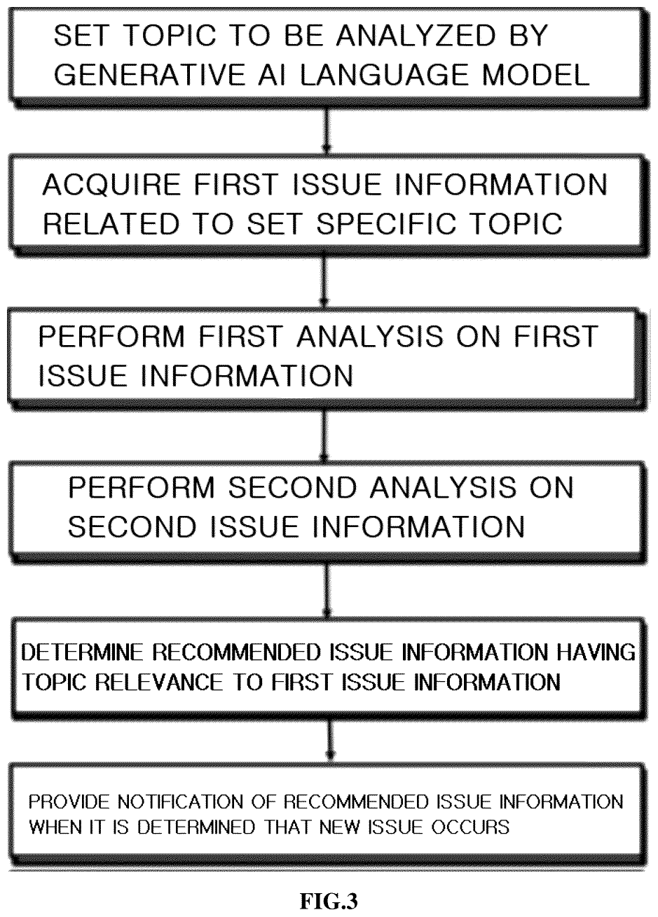

FIG. 3 is an exemplary diagram for explaining an operation of an analysis unit 120 according to an exemplary embodiment.

According to an exemplary embodiment, the specific topic may be input in advance from the user to be set or determined according to a predetermined rule, based on data acquired through the interface unit 110. For example, the specific topic may be at least one of a person, a product, a country, and an event. For example, the analysis unit 120 may determine the specific topic based on information about at least one of a person, a product, a country, and an event extracted from data acquired through the interface unit 110.

For example, with respect to an article featuring a character Hong Gil-dong, the user may only be interested in the character Hong Gil-dong himself, but may not be interested in the places where Hong Gil-dong visited or the people whom he met, included in the specific article. However, in the related art, the metadata constructing method of the existing articles has limitations in reflecting this. In contrast, the analysis unit 120 generates the context of the entire article and consumer's interests, including Hong Gil-dong, as metadata. Thereafter, the analysis unit 120 analyzes other images or gossip included in follow-up articles about Hong Gil-dong and generates and transmits related data to consumers.

According to the exemplary embodiment, the analysis unit 120 analyzes an issue about a specific topic from input data received after generating the first metadata to generate second metadata.

For example, the analysis unit 120 may generate metadata for issue monitoring through a generative artificial intelligence based language model. The analysis unit 120 acquires issue information (first issue information) related to the specific topic and may perform first analysis based on the first issue information. During this process, the analysis unit 120 may generate first metadata in the form of core keywords and/or summary sentences for the first issue information.

The analysis unit 120 may generate various metadata including a specific keyword, such as a person, “Hong Gil-dong”, from the first issue information and the metadata may express the issue information in a more structured method. The generated metadata may include elements, such as the definition of a specific topic, the definition of the issue related to the topic, whether the issue is positive/neutral/negative, the occurrence time and continuity of the issue, and its relevance to other issues. By doing this, the analysis unit 120 comprehensively analyzes the issue information and reflects the related context to derive useful information.

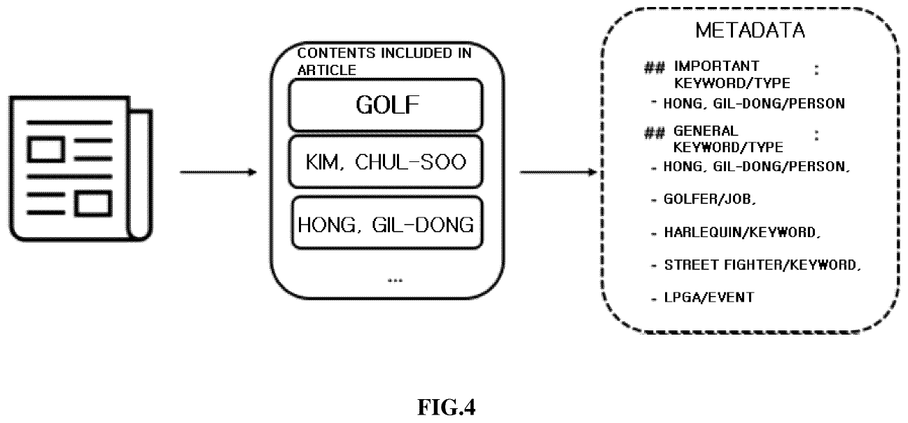

Referring to FIG. 4, the analysis unit 120 receives an article as input data to generate metadata including at least one of an important keyword/type and a general keyword/type based on information included in the article. At this time, the important keyword may be any one of general keywords.

According to the exemplary embodiment, the analysis unit 120 analyzes a similarity of the first metadata and the second metadata to determine whether it is a new issue or a related issue, based on the similarity.

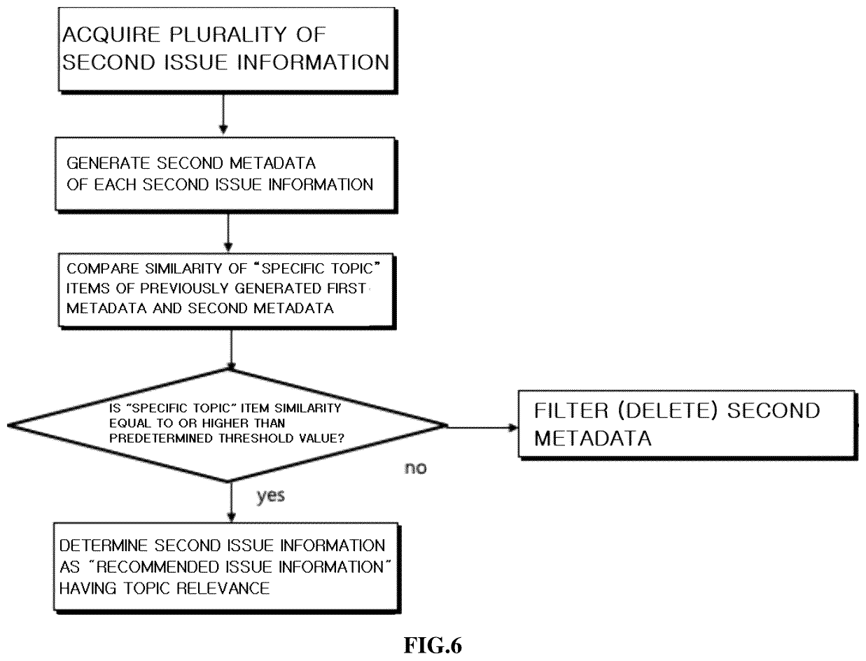

Referring to FIG. 6, after acquiring second metadata about second issue information, the analysis unit 120 may compare a similarity of the first metadata and the second metadata about a “specific topic” item. During this process, the analysis unit 120 may determine the mutual correlation between the first issue information and the second issue information by checking whether the topics are the same or similar, that is, whether the similarity is equal to or higher than a predetermined threshold. For example, when the topic regarding the person “Hong Gil-dong” of the metadata of the first issue information is also included in the metadata of the second issue information, it is considered that two issue information have mutual correlation. For example, the analysis unit 120 may classify the second issue information with the related topic as “recommended issue information”.

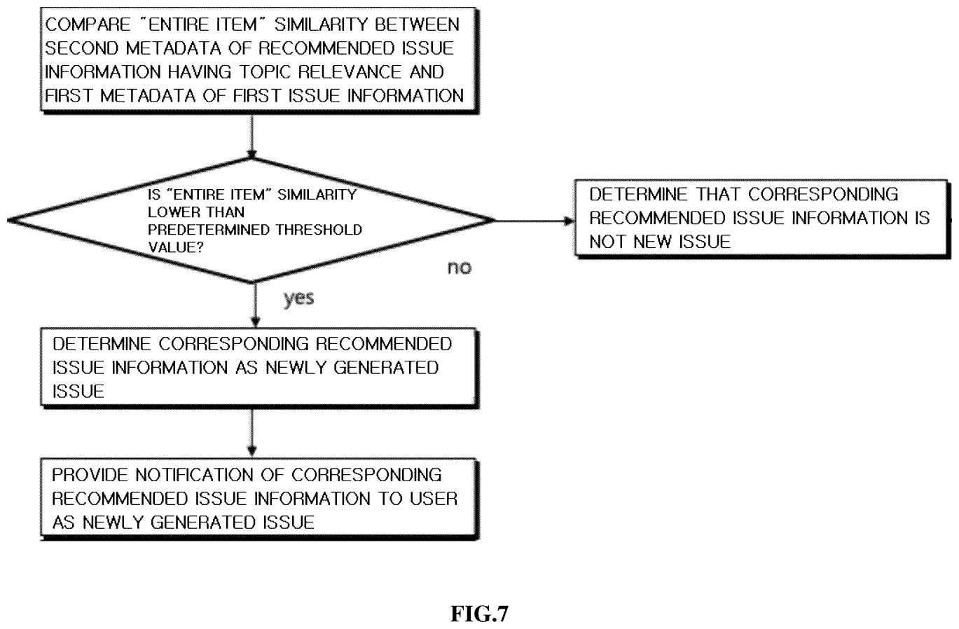

Referring to FIG. 7, the analysis unit 120 may identify the similarity by comparing entire contents of the recommended metadata of the recommended issue information and the first metadata. At this time, when a new content is included in the recommended metadata and thus the similarity is lower than the predetermined threshold value, the analysis unit 120 may determine that a new issue occurs.

For example, the first metadata does not include contents about “golfer/job”, but the recommended metadata newly includes these contents, the issue change indicating that “Hong Gil-dong started ‘golf’ as a job” may be confirmed. Thereafter, when a new issue occurs, the analysis unit 120 may transmit notification information to the user through the interface unit 110.

According to the exemplary embodiment, the analysis unit 120 may generate one or more questions for follow-up data search based on at least one of a specific issue and the first metadata. For example, the analysis unit 120 may request additional questions to the user to additionally acquire ‘specific information’ related to the set specific topic, rather than simply crawling only a specific topic keyword on the Internet. By doing this, the analysis unit 120 may collect more precise information. For example, when a user sets ‘Bitcoin’ as a topic, the analysis unit 120 may create subtopics related to ‘Bitcoin’ (for example, ‘a trend of a financial company’, ‘a trend of a government policy’, etc.) to ask questions to the user and acquire information specified based on the answers and provide the information to the user.

According to an exemplary embodiment, the analysis unit 120 receives answers corresponding to one or more questions and performs search and filtering according to the answers to receive input data. For example, the analysis unit 120 may increase the accuracy of the analysis by pre-filtering information (raw data) searched with a subject keyword (for example, ‘Bitcoin’) with sub-subject keywords (for example, financial companies, government policies, etc.) to determine the scope of the information to be analyzed. Further, when an additional question related to the topic input by the user is generated, the analysis unit 120 searches for “Bitcoin” to extract keywords which are frequently included in information searched for a predetermined period or recently increased rapidly, sorts the keywords according to a priority, and then generates the additional question to provide the question to the user.

According to the exemplary embodiment, the analysis unit 120 repeatedly generates one or more metadata based on input data which is received for a predetermined time and determines a similarity between one or more repeatedly generated metadata to determine metadata having a similarity which is equal to or higher than a predetermined criterion as one or more effective metadata and delete one or more metadata having a similarity which is lower than a predetermined criterion.

According to one example, the analysis unit 120 repeatedly generates metadata for issue information a predetermined number of times and may determine the similarity between the generated metadata. For example, when metadata having a similarity which is equal to or higher than a predetermined threshold value is repeatedly generated, the analysis unit 120 classifies and outputs the corresponding metadata as effective metadata and deletes metadata having a similarity which is lower than a threshold value.

For example, the analysis unit 120 vectorizes the metadata to calculate the distance thereof to calculate the similarity between metadata. However, the present disclosure is not limited thereto and other similarity comparison algorithm may also be used. The analysis unit 120 increases the accuracy of the analysis and efficiently extracts only necessary information by the similarity comparison.

According to the exemplary embodiment, the analysis unit 120 determines any one of one or more effective metadata as representative effective metadata according to a predetermined criterion and determines whether it is a new issue or a related issue based on the representative effective metadata.

For example, the analysis unit 120 additionally generates one “representative effective metadata” representing a plurality of effective metadata according to an implementation condition and utilizes the representative effective metadata for comparison between issue information. By doing this, representativeness of the analyzed issue information may be enhanced and the efficiency of the comparison analysis may be increased.

According to the exemplary embodiment, when two or more topics are included in one issue, the analysis unit 120 performs the clustering for every topic and generates the metadata for every cluster. For example, as the analysis result, when it is confirmed that a plurality of topics is included in the issue information, the analysis unit 120 clusters the corresponding topic to generate metadata and stores and manages the metadata in the DB for every cluster. When a notification of issue change corresponding to a specific cluster is provided in this manner, the analysis unit 120 provides the existing issue situation information to the user by referencing the DB.

For example, if the information indicating that “i) ‘Bitcoin’ has many ETF financial products being launched, but ii) ‘Ethereum’ has delayed the launch of financial products” is included in an article about ‘electronic money’, the analysis unit 120 may perform an analysis summary for each of ‘electronic money-Bitcoin’ and ‘electronic money-Ethereum’, cluster them, and store them in the DB.

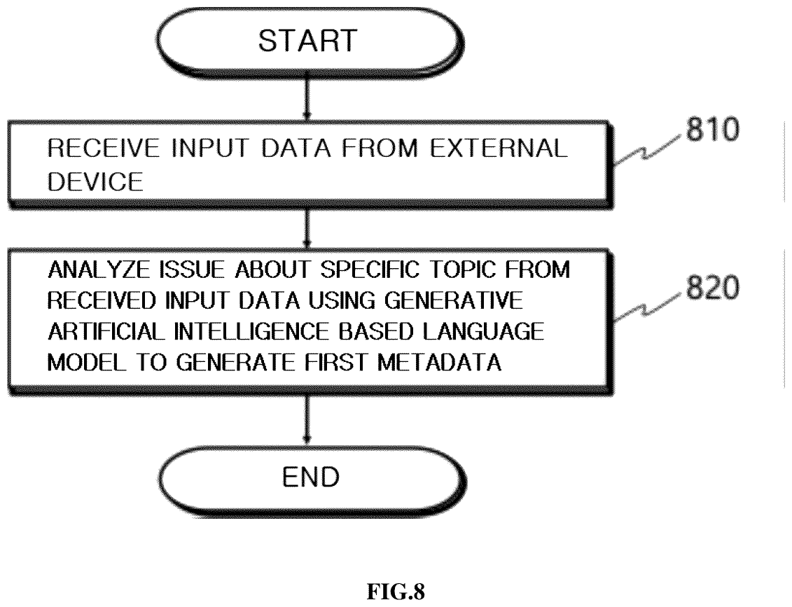

FIG. 8 is a flowchart illustrating an issue monitoring method according to an exemplary embodiment.

According to an exemplary embodiment, the issue monitoring apparatus may be a computing device including one or more processors and a memory which stores one or more programs executed by one or more processors.

According to an example, the issue monitoring apparatus may receive input data from an external device 810 and analyzes an issue about a specific topic from received input data using a generative artificial intelligence based language model to generate first metadata 820.

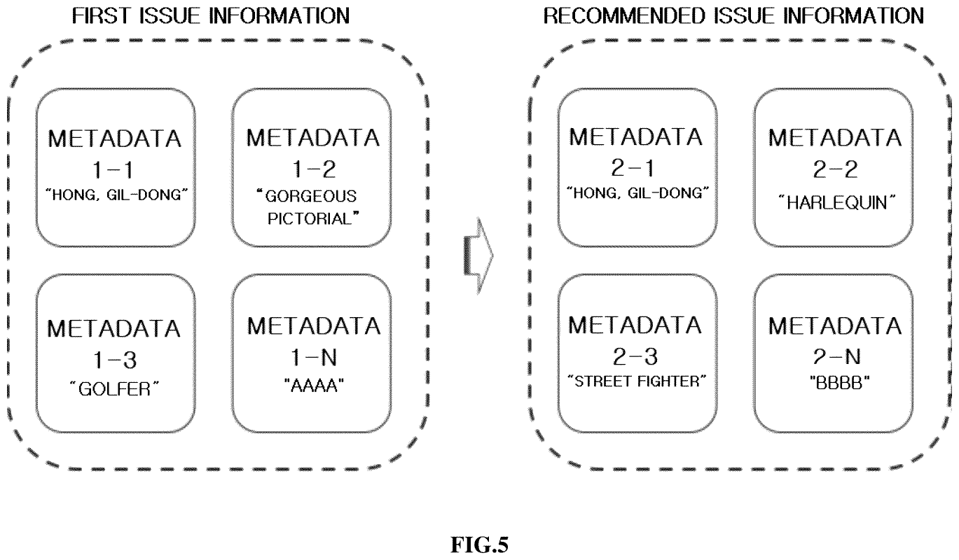

Among the embodiments of FIG. 8, embodiments that overlap with the contents described with reference to FIGS. 1 to 7 are omitted.

In the meantime, according to the exemplary embodiment of the present disclosure, the issue monitoring apparatus may determine the persistence and intensity of the issue changes described above.

For example, even though there is no user's request, the issue monitoring apparatus may search for and/or analyze an issue about a specific topic for which a notification has been provided (for example, articles about a specific topic) for a predetermined period.

Accordingly, if a change in the issue, such as a decrease in search volume for the issue or the occurrence of a follow-up issue, is confirmed, a second notification therefor may be provided to a user terminal.

For example, the issue monitoring apparatus determines the similarity about the issue based on the metadata to determine whether an issue about the specific topic is continued or additional issue change (second issue change) after the first issue change which has been notified first occurs. If the second issue change is confirmed, the issue monitoring apparatus may provide the second issue change to the user terminal as a second notification.

An aspect of the present disclosure may be implemented as computer-readable codes written on a computer-readable recording medium. Codes and code segments which implement the program may be easily deducted by a computer programmer in the art. The computer readable recording medium may include all kinds of recording devices in which data, which are capable of being read by a computer system, are stored. Examples of the computer-readable recording media include ROM, RAM, CD-ROM, magnetic tape, floppy disk, optical disk and the like. Further, the computer readable recording medium is distributed in computer systems connected through a network to be written and executed with a computer readable code in a distributed manner.

For now, the present disclosure has been described with reference to the preferred exemplary embodiments. It is understood to those skilled in the art that the present disclosure may be implemented as a modified form without departing from an essential characteristic of the present disclosure. Accordingly, the scope of the present disclosure is not limited to the above-described embodiment, but should be construed to include various embodiments within the scope equivalent to the description of the claims.

What is claimed is:

1. An issue monitoring apparatus, comprising:
an interface unit which inputs and outputs data with an external device; and
an analysis unit which analyzes an issue about a specific topic from input data received through the interface unit using a generative artificial intelligence based language model to generate first metadata.

2. The issue monitoring apparatus according to claim 1, wherein the specific topic is at least one of a person, a product, a country, and an event which is set in advance by a user or determined according to a predetermined rule based on data acquired through the interface unit.

3. The issue monitoring apparatus according to claim 1, wherein the analysis unit analyzes an issue about the specific topic from input data received after generating the first metadata to generate second metadata.

4. The issue monitoring apparatus according to claim 3, wherein the analysis unit analyzes a similarity of the first metadata and the second metadata and determines whether it is a new issue or a related issue based on the similarity.

5. The issue monitoring apparatus according to claim 4, wherein when a new issue occurs, the analysis unit transmits notification information to the user through the interface unit.

6. The issue monitoring apparatus according to claim 1, wherein the analysis unit generates one or more questions for follow-up data search based on at least one of the specific issue and the first metadata.

7. The issue monitoring apparatus according to claim 6, wherein the analysis unit receives an answer corresponding to one or more questions and performs search and filtering according to the answer to receive input data.

8. The issue monitoring apparatus according to claim 1, wherein the analysis unit repeatedly generates one or more metadata based on input data which is received for a predetermined time and determines a similarity between one or more repeatedly generated metadata to determine metadata having a similarity which is equal to or higher than a predetermined criterion as one or more effective metadata and delete one or more metadata having a similarity which is lower than a predetermined criterion.

9. The issue monitoring apparatus according to claim 8, wherein the analysis unit determines any one of one or more effective metadata according to a predetermined criterion as representative effective metadata and determines whether it is a new issue or a related issue based on the representative effective metadata.

10. The issue monitoring apparatus according to claim 1, wherein when one issue includes two or more topics, the analysis unit performs the clustering for every topic and generates metadata for every clustering.

11. An issue monitoring method which is carried out on a computing device including one or more processors and a memory which stores one or more programs executed by the one or more processors, the method comprising:
a step of receiving input data from an external device; and
an analysis step of analyzing an issue about a specific topic from received input data using a generative artificial intelligence based language model to generate first metadata.

12. The issue monitoring method according to claim 11, wherein the specific topic is at least one of a person, a product, a country, and an event which is set in advance by a user or determined according to a predetermined rule based on data acquired through the interface unit.

13. The issue monitoring method according to claim 11, wherein in the analysis step, an issue about the specific topic is analyzed from input data received after generating the first metadata to generate second metadata.

14. The issue monitoring method according to claim 13, wherein in the analysis step, a similarity of the first metadata and the second metadata is analyzed and it is determined whether it is a new issue or a related issue based on the similarity.

15. The issue monitoring method according to claim 14, wherein in the analysis step, when a new issue occurs, notification information is transmitted to a user.

16. The issue monitoring method according to claim 11, wherein in the analysis step, one or more questions for follow-up data search are generated based on at least one of the specific issue and the first metadata.

17. The issue monitoring method according to claim 16, wherein in the analysis step, an answer corresponding to one or more questions is received and search and filtering are performed according to the answer to receive input data.

18. The issue monitoring method according to claim 11, wherein in the analysis step, one or more metadata is repeatedly generated based on input data which is received for a predetermined time and a similarity between one or more repeatedly generated metadata is determined to determine metadata having a similarity which is equal to or higher than a predetermined criterion as one or more effective metadata and delete one or more metadata having a similarity which is lower than a predetermined criterion.

19. The issue monitoring method according to claim 18, wherein in the analysis step, any one of one or more effective metadata is determined as representative effective metadata according to a predetermined criterion and it is determined whether it is a new issue or a related issue based on the representative effective metadata.

20. The issue monitoring method according to claim 11, wherein in the analysis step, when one issue includes two or more topics, the clustering is performed for every topic and metadata is generated for every clustering.
